(19) United States
(12) Patent Application Publication
(10) Pub. No.: US 2008/0069728 A1
(43) Pub. Date: Mar. 20, 2008

(54) SYSTEM AND METHOD FOR ANALYZING SAMPLES THAT CAN BE MADE TO EMIT GAS

(76) Inventors: Amir J. Attar, Raleigh, NC (US); Dan Edward Stark, Raleigh, NC (US)

Correspondence Address: INTELLECTUAL PROPERTY / TECHNOLOGY LAW, PO BOX 14329, RESEARCH TRIANGLE PARK, NC, 27709, US

(21) Appl. No.: 11/532,533

(22) Filed: Sep. 17, 2006

(51) Int. Cl. G01N 31/22

(52) U.S. Cl. 422/58

(57) ABSTRACT

A system and method for conducting fast and reliable determinations of the presence of specific compounds in a sample based on the gases that are evolved from it upon reaction with specific reagents. The system in one implementation includes a flexible pouch with pre-measured analysis-specific reagents in sealed ampoules placed in a flexible harness and a detection tab placed in slits on top of the pouch. Squeezing the pouch breaks the ampoules and releases the reagents into the sample. The reagents react and if the specific analyte is present in the sample, gas indicative of the analyte is released from the sample and reacts with material on the tab to produce a quantitative change in such material, e.g., a color change. The color change intensity is related to the quantity of the analyte in the sample and may be estimated by comparing it to a standard color chart. In a preferred arrangement, the reagents in the ampoule include, in addition to the reagents needed to react with the target species to form a gas reaction product, additional reagents that react and form a gas to sweep the gaseous product of the primary reaction, to bring it more quickly in contact with the analytical tab, thereby shortening the analysis time.

### BACKGROUND OF THE INVENTION

1. Field of Invention

The present invention relates to a system and method for analyzing samples, e.g., of food, soil, and liquids, to determine the presence of contaminants that are reactive to produce gaseous reaction products that are susceptible to colorimetric detection. In a specific aspect, the invention relates to a kit for performing such detection.

2. Description of the Related Art

Detecting various materials and adulterants in foods, soil, alloys, etc. is a common practice essential to maintaining the integrity of our industry, food supply chains, agriculture etc.

Numerous methods of analysis have been developed for the analysis of various components of mixtures because of the critical importance of such results to our industry and way of life. For example, the detection of ammonium ions in drinking water can indicate either that sewage water has mixed with the drinking water or that a water purification process has not been working adequately. As another example, the presence of arsenic in water presents a severe toxicological risk, while arsenic in food or in the body is potential evidence of intentional poisoning. As a still further example, the presence of cyanides or azides in food evidences intentional adulteration of the food.

Various analysis techniques have been developed that rely on examination of gas that is generated when specific reagents or heat are applied to the sample.

Colorimetric analysis techniques have also been developed that rely on color change of a detection medium in contact with a gas.

One of the most commonly used devices for such colorimetric gas analysis is the Gutzeit type apparatus, which includes a glass tube or other container to which a sample is introduced, followed by addition of the appropriate reagents to carry out the analysis. A colorimetric indicator element, such as a chromogenic tab, is placed on the top of the container and is examined for color change when the reaction stops.

Although various types of such apparatus have been used, however, all of them suffer from similar deficiencies. The chemicals used for the analysis are often typically dangerous reagents, and the user has to manually weigh or measure the correct volume of these dangerous reagents, and place them in a container with a narrow opening, being careful to avoid splashing when the gases begin to evolve. These difficulties are significantly increased when more then one reagent has to be added and mixed with the sample. In addition, reagent preparation and handling are often tedious and time-consuming, and therefore not well-suited for quick performance of the analysis under highly variable field conditions.

Several commercial devices are sold for specific tests such as for testing arsenic in drinking water or soil. These devices overcome various of the aforementioned deficiencies, but are still far from satisfactory. Among these devices are apparatuses for the analysis of arsenic, in which hydrochloric acid and zinc are added to the sample and the gases that evolve are collected in an exterior volume. A tab that includes mercuric bromide on paper is inserted into the top of the apparatus. The tab changes its color based on the amount of arsenic in the sample, by reduction of arsenic compounds to form arsine gas which then reacts with mercury to form the color for analysis. The resulting color then is compared against a color chart to estimate the level of arsenic in the sample.

This reaction reduction is rather sensitive but relatively slow. When a semi-quantitative analysis of very low levels of arsenic is performed, e.g. on a sample of drinking water, over 30 minutes are required to complete a test. The time required for testing can be shortened by adding iron salts, as described in U.S. Patent No. 6,696,300 to I. Jaunakais, et al. Sulfides interfere with this arsenic test, however, since hydrogen sulfide also forms when sulfides are present in the sample, and the presence of hydrogen sulfide causes a brown-black color to form on the mercury bromide tab. Hach analysis for detection of arsenic uses a modified procedure to eliminate such interference by sulfides. However, the Hach analysis requires addition of further reagents, such as Oxone® and sulfamic acid. This in turn increases the time required for analysis, as well as the complexity of the analytical procedure, and reduces the accuracy of the analysis.

The basic Gutzeit reaction for analysis of arsenic involves two reaction steps. The first reaction step involves reduction of the arsenic compounds to gaseous arsine using nascent hydrogen produced by the reaction of hydrochloric acid and zinc. The arsine gas evolves from the solution according to the following reaction:

As⁺ⁿ+Zn+HCl→AsH₃↑+ZnCl₂ (1)

and the arsine then is detected by its reaction with mercuric ions:

AsH₃+Hg⁺²→yellow-brown-black color (2)

The minimal number of reagents needed to accomplish the release of arsine is two, hydrochloric acid and zinc. Measured amounts of these reagents have to be added to the sample and they of course have to be kept separated from one another until added.

It would be a substantial advance in the art to provide a system and corresponding method for rapid, safe, effective and economical detection of target species, such as contaminants, toxins, and otherwise hazardous or unwanted components, in a sample susceptible to the presence of such target species, in which the target species is reactive with a chemistry, e.g., one or more chemical reagents, to generate a gaseous reaction product that is reactive with a calorimetric indicator to effect a color change indicative of presence of the target species.

### SUMMARY OF THE INVENTION

The present invention relates to a system and method for analysis of samples susceptible to presence of a target species therein, in which the target species is reactive with a chemistry, e.g., one or more chemical reagents, to generate a gaseous reaction product that is reactive with a calorimetric indicator to effect a color change indicative of presence of the target species.

The present invention greatly simplifies the analysis of samples of various materials such as soil, water, food, stomach contents, etc., in which a solid and/or liquid material requires analysis to determine or verify presence of contaminants, biohazardous materials, poisons, toxins or other target substances. The system of the invention employs simple components and technique that enable even a layperson to conduct accurate analyses of materials for specific components, under variable field conditions, without the need for complex and expensive laboratory facilities or instrumentation.

The invention in one embodiment relates to an analysis system including a flexible pouch, e.g., formed of plastic or other flexible material of construction, containing one or more ampoules holding measured amounts of reagents specific to the analysis to be performed. When multiple ampoules are present in the pouch, they may be secured to one another, and optionally to the pouch itself (e.g., on an interior wall surface thereof), with a plastic harness, retention band or other securement member.

The pouch in one embodiment is formed with a line or other indicium thereon indicating a fill level, to which the interior volume of the pouch is to be filled to carry out the specific chemical analysis.

The ampoules may be formed of thin-walled material so as to be frangible in character, and/or the ampoule may be scored or grooved, in order to facilitate its breakage and opening when manual pressure is applied thereto. The thin-walled material may be formed of a polymeric or resinous material, or a cellulosic or fibrous material, so that the ampoule in the absence of applied manual pressure leak-tightly retains the chemical reagent therein, but under applied manual pressure readily yields to opening, to dispense the chemical reagent therefrom, into the interior volume of the pouch for mixing and chemical reaction.

After the user places a sample in the pouch up to the marked fill volume, the user inserts a chromophoric tab in a slit on the top of the pouch and then squeezes the pouch. The squeezing breaks the thin-skinned ampoule(s) to release reagent(s) into the pouch. The reagent(s) react with the sample and a gas that is characteristic of the analyte is released. When the gas reaches the chromogenic tab, it changes its color if the particular analyte is present in the gas.

The foregoing system and associated methodology were developed and tested for the analysis of arsenic, chlorides, bromides, iodides, nitrates and nitrites, ammonium compounds, cyanides, carbides, fluorides, sulfites, sulfides, phosphides, antimony compounds, germanium compounds, etc.

Thus, while the invention is further described hereinafter with reference to analysis of samples for the presence of arsenic compounds, it will be understood that the utility of the invention is not thus limited, but rather extends to and encompasses the detection of various other target species that may be reacted to evolve a gas for which a chromophoric substance undergoes a color change to indicate presence of such target species.

Accordingly, the analytical method and the system have general applicability, and the system of the invention can be used with all samples and analysis provided that reagents are available that react with the sample to release a characteristic gas enabling a colorimetric change to be detected when the specific substance of interest is present in the sample.

Although the easiest way to analyze the sample is by effectuating a color change on a chromophoric tab, other methods may also be used to detect the gas generated from the sample in a readily visualized manner, such as by the use of fluorescent or phosphorescent reagents.

Another analytical option involves absorbing the generated gas on porous material such as impregnated glass wool or cotton and then extracting the absorbing material by an appropriate solvent and analyzing the resulting solution.

In addition to the system as constituted to provide measured quantities of the reagents, the analysis time is greatly shortened by utilizing chemistries that enable the gas to evolve quickly, providing a “scrubbing effect” that releases gas from the sample. This scrubbing effect shortens the analysis time drastically. Such scrubbing enhancement can be used in instances in which the sample is either acidic or alkaline during the analysis.

The invention therefore contemplates a system and method for conducting fast and reliable determinations of the presence of specific compounds in a sample based on the gases that are evolved from it upon reaction with specific reagents. The system in one implementation includes a flexible pouch with pre-measured analysis-specific reagents in sealed ampoules placed in a flexible harness and a detection tab placed in slits on top of the pouch. Squeezing the pouch breaks the ampoules and releases the reagents into the sample. The reagents react and if the specific analyte is present in the sample, gas indicative of the analyte is released from the sample and reacts with material on the tab to produce a quantitative change in such material, e.g., a color change. The color change intensity is related to the quantity of the analyte in the sample and may be estimated by comparing it to a standard color chart.

In one preferred arrangement, the reagents in the ampoule include, in addition to the reagents needed to react with the target species to form a gas reaction product, additional reagents that react and form a gas to sweep the gaseous product of the primary reaction, to bring it more quickly in contact with the analytical tab, thereby shortening the analysis time.

The system and method of the invention are applicable to the analysis of samples containing compounds of arsenic, phosphorous, antimony, sulfides, cyanides, azides, ammonium, hydrazines, methyl hydrazines, sulfur dioxide, nitrates, nitrites, boron, germanium, persulphates, chlorides, bromides, iodides, fluorides, hypochlorides, hypobromides, hypoiodides, chlorates, bromates, iodates, etc.

A preferred embodiment of the invention relates to the use of the system and the gas emission acceleration concept for the analysis of arsenic compounds using the Gutzeit reaction.

Other aspects, features and embodiments of the invention will be more fully appreciated from the ensuing disclosure and appended claims.

### BRIEF DESCRIPTION OF THE DRAWINGS

FIG. 1 shows a system according to one embodiment of the invention, as useful to determine the presence of a target species in a solid and/or liquid sample.

FIG. 2A is a side elevation view of a pouch useful in the system of the invention, in one embodiment thereof.

FIG. 2B is a top plan view of the pouch of FIG. 2A.

FIG. 3A is a side elevation view of a harness used to secure chemical reagent ampoules to one another in the interior volume of the pouch, in one embodiment of the invention.

FIG. 3B is a top plan view of the harness of FIG. 3A.

FIG. 4 is a schematic representation of an ampoule of a type usefully employed in the practice of the invention, according to one embodiment thereof.

FIG. 5A is a front elevation view of a clamp usefully employed to close the pouch after addition of a sample thereto, according to one embodiment of the invention.

FIG. 5B is a cross-sectional view of the clamp of FIG. 5A.

### DETAILED DESCRIPTION OF THE INVENTION

The present invention provides a system and method for analyzing samples for presence of a target species therein, in which the target species is reactive with one or more chemical reagents, to generate a gaseous reaction product that in turn is reactive with a calorimetric indicator to effect a color change indicative of presence of the target species.

Many chemical reactions exist that cause a characteristic gas to be evolved from a sample by addition of specific chemical reagents to the sample. The present invention enables any gas-emitting reaction to be used in an analytical procedure, provided that an appropriate tab exists that changes its color when exposed to the emitted gas. Target species that can be detected in samples using the system and method of the invention include, without limitation, cyanides, azides, nitrates, nitrites, ammonia, carbonates, carbides, fluorides, chlorides, bromides, sulfides, phosphides, antimony compounds, etc. Chemical reagents needed to release gases from samples containing such target species, and chromophoric reactions needed to determine the presence of the target species in the sample, can be readily determined within the skill of the art and without undue experimentation, based on the disclosure herein.

The present invention contemplates use of chemistries that provide high rate evolution of gas from the sample to facilitate detection of the target species when present in the sample.

The invention provides a system designed to greatly simplify the process of analyzing samples that emit a characteristic gas upon mixing with specific reagents. Using the system of the present invention, even a layperson can analyze a sample and obtain correct results under field conditions. The invention enables extremely rapid analysis to be achieved.

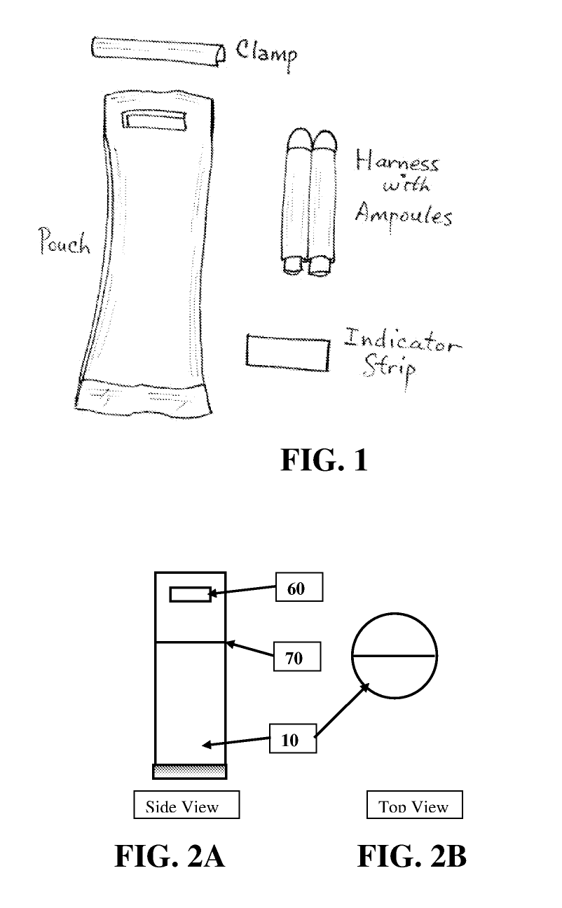

FIG. 1 shows a system according to one embodiment of the invention, as useful to determine the presence of a target species in a solid and/or liquid sample.

The system in this embodiment includes a flexible pouch for holding the sample, a harness for holding ampoules containing reactive reagents, ampoules containing reagents, a clip for closing the pouch, and a tab with a chromogenic chemical that reacts and changes its color once exposed to the evolving gas. The top of the pouch has two narrow flat holes, which are used to hold and support the tab while conducting the analysis.

FIG. 2A is a side elevation view of a pouch 10 useful in the system of the invention, in one embodiment thereof. The pouch has a fill line 70 indicating the level to which sample is to be introduced into the interior volume of the pouch. At the upper portion of the pouch are two narrow flat holes 60 for holding the tab (indicator strip) while conducting the analysis.

FIG. 2B is a top plan view of the pouch of FIG. 2A.

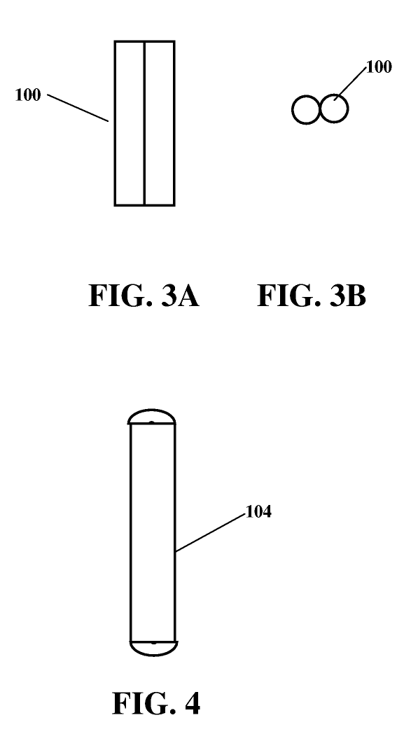

FIG. 3A is a side elevation view of a harness 100 used to secure chemical reagent ampoules to one another in the interior volume of the pouch, in one embodiment of the invention.

FIG. 3B is a top plan view of the harness 100 of FIG. 3A.

FIG. 4 is a schematic representation of an ampoule 104 of a type usefully employed in the practice of the invention, according to one embodiment thereof.

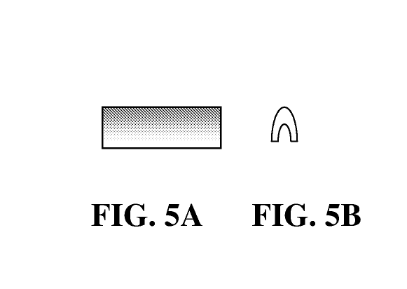

FIG. 5A is a front elevation view of a clamp usefully employed to close the pouch after addition of a sample thereto, according to one embodiment of the invention.

FIG. 5B is a cross-sectional view of the clamp of FIG. 5A.

In one embodiment, the pouch is formed of polyethylene or polyvinyl chloride, and is 1.25 inches in width and diameter, and 4 inches long, with one end thereof being sealed, so that the pouch defines an interior volume therein to which the sample is introduced for analysis. A fill mark is placed about 2.75″ from the sealed bottom of the pouch, and two parallel slits, ⅛ inch in height by ½ inch in length, are cut through it. The width of the chromophoric tab is slightly smaller than ½ inch so that it can be inserted into the slits.

To conduct an analysis, the sealing clip of the pouch is opened and the tab and the harness with the ampoules therein are removed from the interior volume of the pouch (the tab, harness and ampoules being retained in the interior volume of the pouch in the packaged form of the system, prior to use thereof).

Sample material to be analyzed then is introduced into the pouch in sufficient quantity to reach the fill mark, and then the harness with the ampoules therein are inserted back into the pouch. The pouch thereupon is re-sealed and the sides of the pouch are squeezed to break the ampoules and release the chemical reagent therefrom into the pouch. Depending on the analysis to be conducted, one or more ampoules may be in the harness. Depending on the specific analysis to be performed, the ampoules can be broken all at the same time, or one at a time, as necessary or desirable. The pouch contents are now mashed lightly for a few seconds, following which the seal clamp is removed from the pouch and the chromogenic tab is inserted in the slits with the chromogenic reagent facing down, i.e. facing the inside of the pouch. The user waits a short time, depending on the analysis, and then examines the color of the tab. If the color changes, it is an indication of a positive detection of the analyte target species.

A major reduction in the analysis time over conventional analysis tests is achieved by having the sample volume fill line placed on the pouch and the amounts of the various reagents pre-measured and stored in sealed ampoules. A typical analysis is done on 3-10 ml samples but larger or smaller volumes may be accommodated directly or by changing the sizes of the various components.

Since many of the gases formed in the reaction of the reagents with the sample are soluble in the sample media, they are often not released to the air rapidly enough to achieve analysis in a reasonably short period of time. To overcome this difficulty and accelerate the analysis time, a gas scrubbing process can be employed in accordance with the invention, in one aspect thereof, to force the gaseous reaction product to leave the pouch quickly and react with the chromophore.

Since the gas-releasing process consumes some of the reagent, e.g., an acid or a base, the amounts of reagents employed have to be carefully calculated to ensure that a sufficient amount of reagent is available to effect the primary gas releasing reaction.

In addition, the amount of gas released should be controlled, e.g., by proper sizing of the pouch and type and amount of reagent(s), so that overwhelmingly large or overly-fast gas evolution is avoided, in order to prevent foaming of certain samples and/or to prevent excessive dilution of the evolving gas.

Illustrative examples of analysis procedures are described below, including a first example in which the analysis is done in acidic media, and a second example in which the analysis is carried out in basic media. A third example relates to detection of arsenic in foodstuffs.

### EXAMPLE #1

### Enhancement Via Scrubbing of Gas Out of Acidic Samples

This approach is applicable to analysis of cyanides, azides, nitrates, nitrites, carbides, fluorides, chlorides, bromides, sulfides, phosphides, antimony compounds and formaldehyde.

Samples containing compounds of such types are forced to release a gas by adding an acid, e.g., hydrochloric acid or sulfuric acid. To drive the gases out of solution in aqueous media and into the gas phase, one of the reagent ampoules includes the required acid (Ampoule #1), and a material that can react with the acid to form a gas is included in a second ampoule (Ampoule #2). The gas that forms in the resulting reaction scrubs the gaseous analyte and carries it out of the sample to the chromophoric tab. Examples of reagents that may be used in such a manner in Ampoule #2 are inorganic carbonates, which react with some of the acid released from Ampoule #1. This reaction (reaction (3) below) releases carbon dioxide which scrubs the gas out of the sample, and shortens the analysis time.

2HCl+CO₃⁻²→H₂O+2Cl⁻¹+CO₂↑ (3)

The materials to be utilized for gas scrubbing enhancement are selected so as not to affect the analytical reaction. Moreover, the rate of evolution of scrubbing gas has to be about the same as the rate of evolution of gas from the analytical reaction (the gas from the analytical reaction being the gas that contains the analyte of interest). For example, if the analytical reaction is fast and carbonates are used to generate carbon dioxide, then sodium or potassium carbonates may provide effective scrubbing action. If the reaction is not very fast, then calcium, magnesium or barium carbonates may be preferred for generating the scrubbing gas. As a generalized reagent for such reaction, calcium carbonate provides the best overall performance, and is correspondingly preferred as a reagent for effecting scrubbing action.

### EXAMPLE #2

### Enhancement Via Scrubbing of the Gas Out of Alkaline Samples

This procedure is applicable to the analysis of ammonia, small primary amines, carbides and formaldehyde.

Samples containing compounds of such type are forced to release a gas by adding a strong base, e.g., sodium or potassium hydroxides. To drive the gases out of their solution in the aqueous media and into the gas phase, one of the reagent ampoules includes the required base (Ampoule #1) and a material that can react with the base to form a gas is included in a second ampoule (Ampoule #2). The gas that forms in this way scrubs the gaseous analyte and carries it out to the chromophoric tab. Examples of reagents that may be used in such a manner in Ampoule #2 are metals, which react with some of the base released from Ampoule #1. This reaction releases hydrogen gas, which scrubs the gas out and shortens the analysis time. Since hydrogen is also a reducing agent, it may change the nature of some of the other components of the system. However, under the test conditions, the analysis of ammonia and amines is not affected by the process, and corresponding behavior (non-affected by hydrogen) is contemplated for formaldehyde and acetylene (from carbides).

### EXAMPLE #3

### Utilization of the System for the Analysis of Arsenic In Food

### System Components

A. Pouch: 1″ diameter, 4″ long, 20 mils thick PVC, sealed on one side and with two slots, ⅛ inch by ½ inch placed ¼ inch from the open end.
B. A CPVC clamp 1 inch long and ¼ inch tall, capable of sealing the top of the pouch.
C. A polyethylene harness with two openings for two ampoules 7.6 Φ mm by 55 mm. The harness length is 50 mm.
D. A ½ inch×¾ inch detection tab (chromophoric strip).

### Contents of Ampoules

A. Ampoule #1: 0.85 gm 37% HCl with 0.001 mg Methyl red covered by 0.1 gm mineral oil BP 140-160 C.
B. Ampoule #2: 0.2 gm zinc powder, free from sulfur and arsenic, and 0.1 gm calcium carbonate.

### Detection Tab.

A ½ inch×1 inch, 250 microns thick, activated 2 microns diameter silica powder on 10 mils polyester film impregnated with 10 microliters of a solution of 0.3 grams K₂HgBr₄ in water, dried in air 3 hours.

### Mode of Operation.

To the empty pouch add the food sample to the fill level, about 7 grams. Place the harness with the ampoules back in the pouch and seal it with the clamp. Squeeze the outside of the pouch to break the ampoules and gently massage the pouch for 5-10 seconds. Remove the clamp and insert the detection tab in the slots reagent side down. Wait 45-90 seconds and look at the color developed on the tab. Greater arsenic concentration produces more intense color on the tab. Low concentrations produce a yellow color which intensifies to brown and eventually to black.

Thus, the invention contemplates a system for analyzing a sample that can be induced to emit a characteristic gas when a target species is present in the sample, said system comprising:

a flexible pouch sealed at a bottom portion thereof and open at a top portion thereof;

at least one sealed ampoule each containing a pre-measured amount of reagent, each said ampoule being adapted to be broken by application of exterior pressure on the pouch to release the reagent therein, wherein said reagent is reactive with said target species to produce a gas; and

a calorimetric indicator tab adapted with said pouch to be inserted into said top portion of said pouch for contact with said gas to produce a calorimetric change indicative of presence of the target species in the sample.

In one embodiment, the pouch includes a fill-line mark to indicate the level of sample to be placed in the pouch for sample analysis. In another embodiment, the pouch is slotted or notched at its top to accommodate insertion of the calorimetric indicator tab into the top portion of said pouch. The analytical system can include multiple ampoules secured by a harness, and independently can include a clamp adapting for sealing of the top portion of said pouch.

In one embodiment of such system, the pouch contains slots at an upper portion thereof, and the calorimetric tab comprises a chromogenic tab insertable into the slots.

The ampoules can be constructed of thin-skinned material selected from the group consisting of glass and plastic. The ampoules preferably are sealed in an inert atmosphere, and may include additives permitting their leak-tight sealing. The ampoules optionally can include colored materials adapted to facilitate assembly of the ampoules and reduce error during their use. The harness additionally can be color-coded.

The system of the invention can be adapted to analyze a sample selected from the group consisting of water, soil, sediments, food, drugs, stomach contents, industrial materials, paints, treated wood, industrial chemicals, household products, poisons, by products, landfill materials, waste materials, and environmental samples.

The system can include multiple ampoules wherein at least one of the ampoules contains an acid and another ampoule contains a material which reacts with the acid to produce gas.

The reagent that produces gas by reacting with the acid can comprise an inorganic carbonate that produces carbon dioxide upon reaction with acid, wherein said inorganic carbonate is selected from the group consisting of sodium carbonate, potassium carbonate, calcium carbonate barium carbonate, and magnesium carbonate.

The system in another embodiment includes multiple ampoules wherein at least one of ampoules contains a base and another ampoule contains a material that reacts with the base to produce gas. The reagent that produces gas by reacting with the base can include a metal producing hydrogen as the gas.

The system in a specific embodiment includes printed instructions for use of the system to analyze samples for the presence of arsenic compounds, antimony compounds, azides, cyanides, sulfides, boron compounds, nitrates, nitrites, carbonates, carbides, phosphides, germanium compounds, fluorides, chlorides, bromides, iodides, hypochlorites, chlorates, perchlorates, bromates, hypobromates, ozonides, ammonium, amines, hydrazines, methyl-hydrazines, formaldehyde and other small molecules.

The system may include a pouch constructed of a flexible thin material selected from the group consisting of polyethylene, polyvinyl chloride, polypropylene, fluorinated polymers, polytetrafluoroethylene, and thin flexible metallic films of metal selected from the group consisting of aluminum, copper, nickel, and platinum.

The system in another embodiment includes printed instructions for use of the system to analyze samples for the presence of materials which can be reduced to form a volatile gas and comprising multiple ampoules, wherein one ampoule contains an acid such as hydrochloric acid and another ampoule contains a metal which reacts with acid to produce a reducing gas. The system in a particular embodiment can include a gas-forming material in a separate ampoule or with the metal. The gas-forming material may for example include a carbonate selected from the group consisting of sodium carbonate, potassium carbonate, calcium carbonate barium carbonate, and magnesium carbonate, to produce carbon dioxide upon reaction with acid.

The system in another embodiment includes printed instructions for use of the system to analyze samples for arsenic by reducing arsenic compounds to arsine using measured amounts of hydrochloric or sulfuric acid in one ampoule and zinc powder in another ampoule and wherein calcium carbonate is used to generate carbon dioxide in-situ to drive the arsine out of the pouch. Such a system can include a calorimetric indicator tab comprising a chromophoric reagent reactive with arsine whereby the arsine which evolves from the sample is detected by its color reaction, wherein said chromophoric reagent is selected from the group consisting of mercuric salts, silver salts, and copper salts.

The calorimetric tab in a specific embodiment can include a thin layer of high-surface area fine solid particles deposited on a flat substrate. Suitable materials for such particles include silica, alumina, magnesia, lanthanum oxide, titanium oxide, thoria and other metal oxides.

The thin layer of particles can be deposited on a porous material such as paper or on a plastic film such as polyester or other plastic, or on a polymeric membrane such as Nylon membrane, cellulose or nitrocellulose membrane, or similar materials.

In a further embodiment, the system includes an ampoule containing acid, for generating gas in contact with the sample material, wherein said gas is selected from the group consisting of hydrogen cyanide or cyanogen from cyanides, hydrazoic acid from azides, nitrogen oxides from nitrites and nitrates, hydrofluoric acid from fluorides, hydrochloric acid from chlorides, hydrobromic acid from bromides, hydroiodic acid and iodine from iodides, chlorine and its oxides from hypochlorites, chlorates, perchlorates and related chlorine compounds, bromine and hydrobromic acid from bromates, hypobromates and related compounds, carbon dioxide from carbonates and isocyanates, and acytylene from carbides.

The system may be constructed with an ampoule containing acid, wherein gas is produced in the pouch as a result of action of acid released from said ampoules and an oxidizing material released from another ampoule.

And another alternative, the system may be configured with an ampoule containing acid, wherein gas is produced in the pouch as a result of action of acid released from one of the ampoules and a material which produces a reducing material by reacting with the acid from another ampoule. The material that produces a reducing material by reacting with the acid from another ampoule can for example include a metal powder, and the reducing material produced by the reaction of the acid released from one ampoule on the metal powder can be hydrogen. The acid from another ampoule can be hydrochloric acid and the metal powder can be zinc.

The system can be adapted to detect a target species selected from the group consisting of arsenic, phosphorous, antimony, germanium and sulfur compounds. For such purpose, the calorimetric tab may include a bibulous material impregnated with a solution containing a salt of the anionic complex mercuric tetra bromide. The bibulous material itself can include material selected from the group consisting of paper, cotton, and thin layers of silica or alumina particles on a plastic, metal or glass support.

The system may be configured to include an ampoule containing an alkaline base. The alkaline base may include a base selected from the group consisting of sodium hydroxide and oxide, potassium hydroxide and oxide, calcium hydroxide and oxides, barium hydroxide and oxides, lithium hydroxide and oxide and related alkali or alkali-earth oxides and hydroxides. The alkaline base may be adapted to cause the release of ammonia, amines, hydrazine, methyl hydrazines, acetylene etc.

The system in another arrangement comprises an ampoule containing a reagent adapted to produce gas for sweeping out the gaseous reaction products by reacting with zinc. The system in another embodiment can include an ampoule containing an alkaline or alkaline-earth metal, an ampoule containing a pH indicator, an ampoule containing zinc, or an ampoule containing a dye. The system may include a reagent having a layer of inert material covering it.

The analytical system of the invention in one embodiment includes an ampoule containing an acid selected from the group consisting of hydrochloric, sulfuric, nitric, phosphoric, and citric, or oxides which form acids in contact with water, comprising phosphorous pentoxide, and salts which hydrolyze and form acids, selected from the group consisting of zinc chloride, titanium chloride, and tin chloride.

In a particular embodiment, the harness accommodates from 1 to 6 ampoules of reagents.

The system in a further embodiment can include a color-comparison chart with colors corresponding to different concentrations of analytes in the sample printed thereon to facilitate color comparison for semi-quantitative analytical purposes.

In yet another embodiment, the system includes an external color-comparison chart with colors corresponding to different concentrations of analytes in the sample printed thereon to facilitate color comparison for semi-quantitative analytical purposes.

While the invention has been described herein with respect to specific features, aspects and embodiments, it will be appreciated that the invention is not thus limited, but rather extends to and encompasses variations, modifications and alternative embodiments, such as will suggest themselves to those of ordinary skill in the art, based on the disclosure herein. Accordingly, all such variations, modifications and alternative embodiments are to be regarded as being within the spirit and scope of the invention as hereinafter claimed.

What is claimed is:

1. A system for analyzing a sample that can be induced to emit a characteristic gas when a target species is present in the sample, said system comprising:
a flexible pouch sealed at a bottom portion thereof and open at a top portion thereof;
at least one sealed ampoule each containing a pre-measured amount of reagent, each said ampoule being adapted to be broken by application of exterior pressure on the pouch to release the reagent therein, wherein said reagent is reactive with said target species to produce a gas; and
a calorimetric indicator tab adapted with said pouch to be inserted into said top portion of said pouch for contact with said gas to produce a calorimetric change indicative of presence of the target species in the sample.

2. The system of claim 1 wherein the pouch includes a fill-line mark to indicate the level of sample to be placed in the pouch for sample analysis.

3. The system of claim 1 where the pouch is slotted or notched at its top to accommodate insertion of the calorimetric indicator tab into the top portion of said pouch.

4. The system of claim 1 including multiple ampoules secured by a harness.

5. The system of claim 1 including a clamp adapting for sealing of the top portion of said pouch.

6. The system of claim 1 wherein the pouch contains slots at an upper portion thereof, and the calorimetric tab comprises a chromogenic tab insertable into the slots.

7. The system of claim 1 comprising ampoules constructed of thin-skinned material selected from the group consisting of glass and plastic.

8. The system of claim 1 comprising ampoules sealed in inert atmosphere.

9. The system of claim 1 comprising ampoules including additives permitting their leak-tight sealing.

10. The system of claim 1 comprising ampoules including colored materials adapted to facilitate assembly of said ampoules and reduce error during their use.

11. The system of claim 4 wherein the harness is color-coded.

12. The system of claim 1 as adapted to analyze a sample selected from the group consisting of water, soil, sediments, food, drugs, stomach contents, industrial materials, paints, treated wood, industrial chemicals, household products, poisons, by products, landfill materials, waste materials, and environmental samples.

13. The system of claim 1 comprising multiple ampoules wherein at least one of ampoules contains an acid and another ampoule contains a material which reacts with the acid to produce gas.

14. The system of claim 13 wherein the reagent that produces gas by reacting with the acid comprises an inorganic carbonate that produces carbon dioxide upon reaction with acid, wherein said inorganic carbonate is selected from the group consisting of sodium carbonate, potassium carbonate, calcium carbonate barium carbonate, and magnesium carbonate.

15. The system of claim 1 comprising multiple ampoules wherein at least one of ampoules contains a base and another ampoule contains a material that reacts with the base to produce gas.

16. The system of claim 15 wherein the reagent that produces gas by reacting with the base comprises a metal producing hydrogen as said gas.

17. The system of claim 1 including printed instructions for use of the system to analyze samples for the presence of arsenic compounds, antimony compounds, azides, cyanides, sulfides, boron compounds, nitrates, nitrites, carbonates, carbides, phosphides, germanium compounds, fluorides, chlorides, bromides, iodides, hypochlorites, chlorates, perchlorates, bromates, hypobromates, ozonides, ammonium, amines, hydrazines, methyl-hydrazines, formaldehyde and other small molecules.

18. The system of claim 1 where the pouch is constructed of a flexible thin material selected from the group consisting of polyethylene, polyvinyl chloride, polypropylene, fluorinated polymers, polytetrafluoroethylene, and thin flexible metallic films of metal selected from the group consisting of aluminum, copper, nickel, and platinum.

19. The system of claim 1 including printed instructions for use of the system to analyze samples for the presence of materials which can be reduced to form a volatile gas and comprising multiple ampoules, wherein one ampoule contains an acid such as hydrochloric acid and another ampoule contains a metal which reacts with acid to produce a reducing gas.

20. The system of claim 19 comprising a gas-forming material in a separate ampoule or with the metal.

21. The system of claim 20 where the gas-forming material comprises a carbonate selected from the group consisting of sodium carbonate, potassium carbonate, calcium carbonate barium carbonate, and magnesium carbonate, to produce carbon dioxide upon reaction with acid.

22. The system of claim 19 including printed instructions for use of the system to analyze samples for arsenic by reducing arsenic compounds to arsine using measured amounts of hydrochloric or sulfuric acid in one ampoule and zinc powder in another ampoule and wherein calcium carbonate is used to generate carbon dioxide in-situ to drive the arsine out of the pouch.

23. The system of claim 22 wherein the calorimetric indicator tab includes a chromophoric reagent reactive with arsine whereby the arsine which evolves from the sample is detected by its color reaction, wherein said chromophoric reagent is selected from the group consisting of mercuric salts, silver salts, and copper salts.

24. The system of claim 1 wherein the tab includes a thin layer of high-surface area fine solid particles deposited on a flat substrate.

25. The system of claim 24 wherein the particles comprise a material selected from the group consisting of silica, alumina, magnesia, lanthanum oxide, titanium oxide, thoria and other metal oxides.

26. The system of claim 24 where the thin layer of particles is deposited on a porous material such as paper or on a plastic film such as polyester or other plastic, or on a polymeric membrane such as Nylon membrane, cellulose or nitrocellulose membrane, or similar materials.

27. The system of claim 1 comprising an ampoule containing acid, for generating gas in contact with the sample material, wherein said gas is selected from the group consisting of hydrogen cyanide or cyanogen from cyanides, hydrazoic acid from azides, nitrogen oxides from nitrites and nitrates, hydrofluoric acid from fluorides, hydrochloric acid from chlorides, hydrobromic acid from bromides, hydroiodic acid and iodine from iodides, chlorine and its oxides from hypochlorites, chlorates, perchlorates and related chlorine compounds, bromine and hydrobromic acid from bromates, hypobromates and related compounds, carbon dioxide from carbonates and isocyanates, and acytylene from carbides.

28. The system of claim 1 comprising an ampoule containing acid, wherein gas is produced in the pouch as a result of action of acid released from said ampoules and an oxidizing material released from another ampoule.

29. The system of claim 1 comprising an ampoule containing acid, wherein gas is produced in the pouch as a result of action of acid released from one of the ampoules and a material which produces a reducing material by reacting with the acid from another ampoule.

30. The system of claim 29 wherein said material which produces a reducing material by reacting with the acid from another ampoule comprises a metal powder, and the reducing material produced by the reaction of the acid released from one ampoule on the metal powder is hydrogen.

31. The system of claim 30 where the acid from another ampoule comprises hydrochloric acid and the metal powder comprises zinc.

32. The system of claim 31 as adapted to detect a target species selected from the group consisting of arsenic, phosphorous, antimony, germanium and sulfur compounds.

33. The system of claim 32 where the colorimetric tab comprises a bibulous material impregnated with a solution containing a salt of the anionic complex mercuric tetra bromide.

34. The system of claim 33 where the bibulous material impregnated with the solution the salt of the anionic complex mercuric tetra bromide comprises a material selected from the group consisting of paper, cotton, and thin layers of silica or alumina particles on a plastic, metal or glass support.

35. The system of claim 1 wherein the ampoule contains an alkaline base.

36. The system of claim 35 wherein the alkaline base comprises a base selected from the group consisting of sodium hydroxide and oxide, potassium hydroxide and oxide, calcium hydroxide and oxides, barium hydroxide and oxides, lithium hydroxide and oxide and related alkali or alkali-earth oxides and hydroxides.

37. The system of claim 35 wherein the alkaline base is adapted to cause the release of ammonia, amines, hydrazine, methyl hydrazines, acetylene etc.

38. The system of claim 31 comprising an ampoule containing a reagent adapted to produce gas for sweeping out the gaseous reaction products by reacting with zinc.

39. The system of claim 36 comprising an ampoule containing an alkaline or alkaline-earth metal.

40. The system of claim 1 comprising an ampoule containing a pH indicator.

41. The system of claim 1 comprising an ampoule containing zinc.

42. The system of claim 1 comprising an ampoule containing a dye.

43. The system of claim 1 comprising a reagent having a layer of inert material covering it.

44. The system of claim 1 comprising an ampoule containing an acid selected from the group consisting of hydrochloric, sulfuric, nitric, phosphoric, and citric, or oxides which form acids in contact with water, comprising phosphorous pentoxide, and salts which hydrolyze and form acids, selected from the group consisting of zinc chloride, titanium chloride, and tin chloride.

45. The system of claim 4 wherein the harness accommodates from 1 to 6 ampoules of reagents.

46. The system of claim 6 further comprising a color-comparison chart with colors corresponding to different concentrations of analytes in the sample printed thereon to facilitate color comparison for semi-quantitative analytical purposes.

47. The system of claim 6 further comprising an external color-comparison chart with colors corresponding to different concentrations of analytes in the sample printed thereon to facilitate color comparison for semi-quantitative analytical purposes.
